(19) United States
(12) Patent Application Publication
(10) Pub. No.: US 2004/0220847 A1
(43) Pub. Date: Nov. 4, 2004

(54) Method and program for assisting a worker in charge of operations

(76) Inventors: Shoji Ogushi, Nagano-ken (JP); Masanori Kojima, Nagano-ken (JP)

Correspondence Address: SHERIDAN ROSS PC, 1560 BROADWAY, SUITE 1200, DENVER, CO, 80202

(21) Appl. No.: 10/683,570

(22) Filed: Oct. 9, 2003

(30) Foreign Application Priority Data
Oct. 10, 2002 (JP) PAT. 2002-297388
Oct. 6, 2003 (JP) PAT. 2003-347042

(51) Int. Cl. G06F 17/60

(52) U.S. Cl. 705/9

(57) ABSTRACT

A management server stores information on necessary parts and a method for a task in individual memory sections based on reception information received from a client. Information on the parts needed for a task is transmitted to a transport vehicle terminal carried by a transport person in the case where the necessary parts are loaded on the transport vehicle. In the case where a worker in charge has no further tasks that have been accepted, the worker calls up a work request list showing reception numbers, machine types and so forth from the management server. The worker selects workable items from the work request list and sends a command to update information in the individual memory sections in the management server to the management server via a worker terminal.

### BACKGROUND OF THE INVENTION

The present invention relates to a method and a program for assisting a worker in charge of operations in deciding whether to accept a task.

With regard to tasks for which a worker in charge goes to work sites where machines are located and performs repair or maintenance and so forth on the machines, a supervisor or a manager at a management center normally creates a work schedule for the worker. In the case where a new request is received for an unscheduled task, conventionally, the work manager assigns the new task to the proper worker and informs the worker of the task (see Japanese Patent Laid-Open Publication No. 2002-169938) based on a work schedule having been prepared before the worker's departure.

In assigning a new task according to this method, to select the proper worker, the manager should grasp the current locations and working states of workers nearly in real time. Further, the work manager frequently gets contacts through telephones and so forth from workers asking instructions about the work schedules. This places a great burden on the work manager.

Creating a work schedule and assigning a new task should be carried out in consideration of the abilities of workers, such as their skills, the degree of importance of individual tasks, information on work areas and so forth. A person who is experienced and has high ability takes up the post of the work manager who gives such instructions. Such a manager cannot therefore work away from the management center. The conventional method therefore makes it difficult for persons with high abilities to provide actual technical services, so that the overall work cannot proceed efficiently. Further, workers need to stop at the management center or warehouse for parts before going to work sites and get information on work schedules and/or necessary parts. This places an increased burden on each worker.

### SUMMARY OF THE INVENTION

Accordingly, it is a primary object of the present invention to provide a worker assisting method and a worker assisting program which can assist a worker in accepting a task himself or herself. It is another object of the present invention to provide a worker assisting method and a worker assisting program which separately transport parts necessary for a task and allows a worker to receive the parts at a work site.

To achieve the objects, the present invention provides a method for using a computer system. The method is used to assist a worker in deciding whether to accept a work item. The method includes storing reception information representing a work request received from a client in a memory device of the computer system, extracting work items which have not been accepted by the worker from the reception information and sending the extracted work items to a worker terminal used by the worker, receiving acceptance information corresponding to work items selected by the worker from the unaccepted work items, and storing information on the worker in the memory device based on the acceptance information.

The present invention also provides another method of using a computer system. The method is used to assist a worker who goes to a work place to work, in deciding whether to accept a work item. The method includes storing reception information representing a work request received from a client in a memory device, sending work items in the reception information which have not been accepted by the worker to a worker terminal used by the worker, receiving acceptance information corresponding to work items selected by the worker from the unaccepted work items, and storing information on the worker in the memory device based on the acceptance information.

The present invention further provides a computer recording medium on which computer program instructions are recorded. The computer recording medium is used to assist a worker in deciding whether to accept a work item. The computer program instructions are executed by a computer. The computer program instructions have a plurality of steps which are executed by the computer. The computer program instructions include storing reception information representing a work request received from a client, extracting work items which have not been accepted by a worker in charge of work from the reception information, sending the extracted work items to a worker terminal used by the worker, receiving acceptance information corresponding to work items selected by the worker and sent from the worker terminal, and storing information on the worker in a memory device based on the acceptance information.

The present invention also provides a computer recording medium on which computer program instructions are recorded. The computer recording medium is used to assist a worker who goes to a work place and works, in deciding whether to accept a work item. The computer program instructions have a plurality of steps which are executed by the computer. The computer program instructions include storing reception information representing a work request received from a client, sending work items in the reception information which have not been accepted by a worker in charge of work to a worker terminal used by the worker, receiving acceptance information corresponding to work items selected by the worker and sent from the worker terminal; and storing information on the worker in a memory device based on the acceptance information.

Other modes and advantages of the present invention will be readily apparent from the following description together with the accompanying drawings which exemplify the principles of the present invention.

### BRIEF DESCRIPTION OF THE DRAWINGS

The features of the present invention that are believed to be novel are set forth with particularity in the appended claims. The present invention, together with objects and advantages thereof, may best be understood by reference to the following description of the presently preferred embodiments together with the accompanying drawings.

FIG. 1 is a schematic diagram of a system according to a first embodiment of the present invention;

FIG. 2 is an explanatory diagram of data stored in individual memory sections provided in a management server in FIG. 1;

FIG. 3 is an explanatory diagram of a display screen of a service department terminal;

FIG. 4 is an explanatory diagram of a display screen of the service department terminal;

FIG. 5 is an explanatory diagram of a display screen of the service department terminal;

FIG. 6 is an explanatory diagram of a display screen of a terminal of a worker;

FIG. 7 is an explanatory diagram of a display screen of the worker terminal;

FIG. 8 is an explanatory diagram of a display screen of the worker terminal;

FIG. 9 is an explanatory diagram of a display screen of the worker terminal;

FIG. 10 is an explanatory diagram of a display screen of the worker terminal;

FIG. 11 is an explanatory diagram of a display screen of the worker terminal;

FIG. 12 is an explanatory diagram of a display screen of the worker terminal;

FIG. 13 is an explanatory diagram of procedures of the first embodiment;

FIG. 14 is an explanatory diagram of procedures of the first embodiment;

FIG. 15 is an explanatory diagram of procedures of the first embodiment;

FIG. 16 is an explanatory diagram of procedures of the first embodiment;

FIG. 17 is an explanatory diagram of procedures of the first embodiment;

FIG. 18 is an explanatory diagram of data stored in a client information memory section according to a second embodiment of the present invention; and

FIG. 19 is an explanatory diagram of a display screen of a worker terminal according to the embodiment in FIG. 18.

### DETAILED DESCRIPTION OF THE PREFERRED EMBODIMENTS

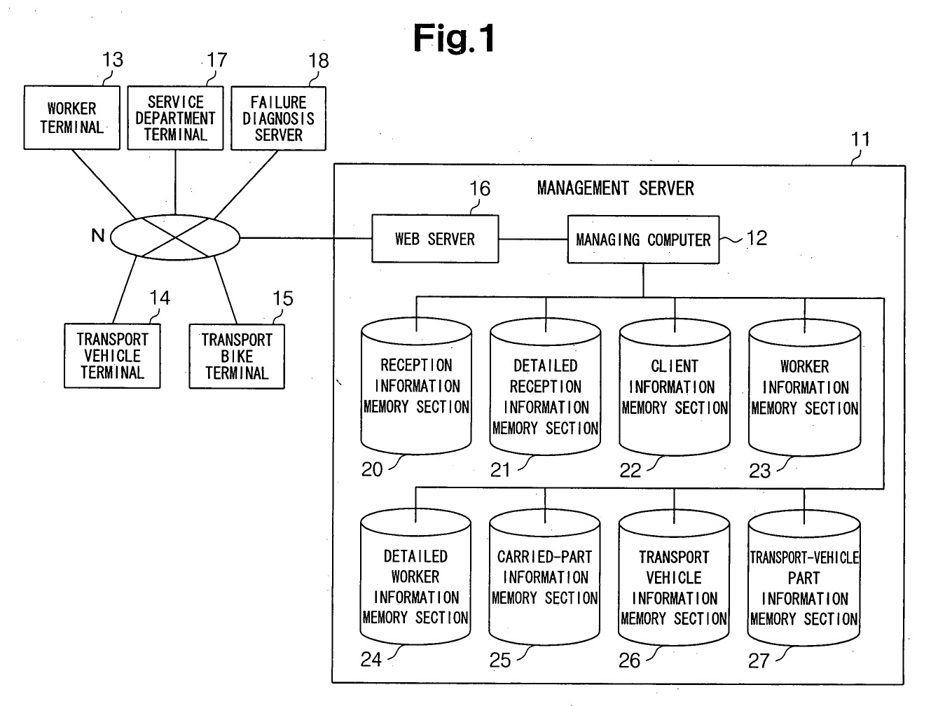

The first embodiment of the present invention will be described below with reference to FIGS. 1 to 17.

In this embodiment, persons who perform the following operations are defined as a worker in charge (or simply “worker”) and a transport person. A worker performs work, such as repair and so forth of a machine in the worker's work area and selects the worker's own work schedule. A transport person transports parts necessary for a task to a worker who is at a work site.

Fields for tasks are separated into a plurality of task areas. A single worker is assigned to each task area for which the worker takes charge. A plurality of workers may be assigned to each task area. A worker performs repair, maintenance and so forth, for example, on products the worker's company has produced or sold or products for which maintenance contracts are in force. Information on the products, such as serial numbers and machine types, has been registered beforehand or is registered when a work request from a client is received.

FIG. 1 is a schematic diagram of the system according to the embodiment. A management server 11 is located in the management center at which work requests from clients are received. The management server 11 has a managing computer 12. The managing computer 12 comprises an unillustrated CPU, RAM and so forth and performs data reading and writing with respect to memory sections 20 to 27, runs various programs and performs data processing. The management server 11 is connected to a worker terminal 13, a transport vehicle terminal 14 and a transport bike terminal 15 over a network N. The worker terminal 13 is a portable telephone terminal used by a worker and has a global positioning system (GPS) function. This GPS function allows the management server 11 to acquire information on the latitude and longitude of the location of the worker via a GPS satellite or the like (not shown) as a position detecting mechanism. The transport vehicle terminal 14 is used by a transport person who takes charge of a transport vehicle, which is a light truck which transports parts to a work site. A single transport vehicle is assigned to plural work areas and drives around the work areas or is standing by. A transport vehicle may be assigned to each work area. The transport vehicle terminal 14 is a portable telephone terminal used by the transport person and has a GPS function. The transport vehicle terminal 14 exchanges information on parts and so forth with the management server 11 over the network N. The functions of the transport vehicle terminal 14 allow the management server 11 to acquire information on the latitude and longitude of the position of the transport vehicle. A transport bike is used to transport those parts, which are not carried around by a worker and are not loaded on the transport vehicle, to a work place. The transport bike terminal 15 is used by a person who is a transport person and who takes charge of a bike. Data stored in the transport bike terminal 15 includes a program for receiving e-mail from the management server 11.

The management server 11 has a web server 16. Installed in the web server 16 is software for content that is displayed on the worker terminal 13. As the worker terminal 13 accesses the web server 16, the screen for assisting the worker is displayed on the worker terminal 13. The software for the content has data for various screens stored therein, such as a display program, etc.

The management server 11 is connected to a service department terminal 17 and a failure diagnosis server 18 over the network N. Information on a work request received from a client is input to the service department terminal 17. The service department terminal 17 transmits the work request information to the management server 11 and the failure diagnosis server 18 over the network N and displays information on the cause of a failure, how to handle the failure, etc. with respect to the work request, received from the failure diagnosis server 18, on the display section. The failure diagnosis server 18 has a memory section where failure information on the cause of a failure and how to handle the failure corresponding to the failure status, and a program for diagnosing the cause of a failure and how to handle the failure. The failure diagnosis server 18 determines the cause of a failure and how to handle the failure from information of the failure status of a machine and sends information on the cause of a failure, such as how to handle the failure, required parts, etc., to the service department terminal 17. In the embodiment, the management server 11, the service department terminal 17 and the failure diagnosis server 18 constitute a computer system.

The management server 11 has a reception information memory section 20, a detailed reception information memory section 21, a client information memory section 22, a worker information memory section 23, a detailed worker information memory section 24, a carried-part information memory section 25, a transport vehicle information memory section 26 and a transport-vehicle part information memory section 27. The reception information memory section 20 and the detailed reception information memory section 21 function as memory devices.

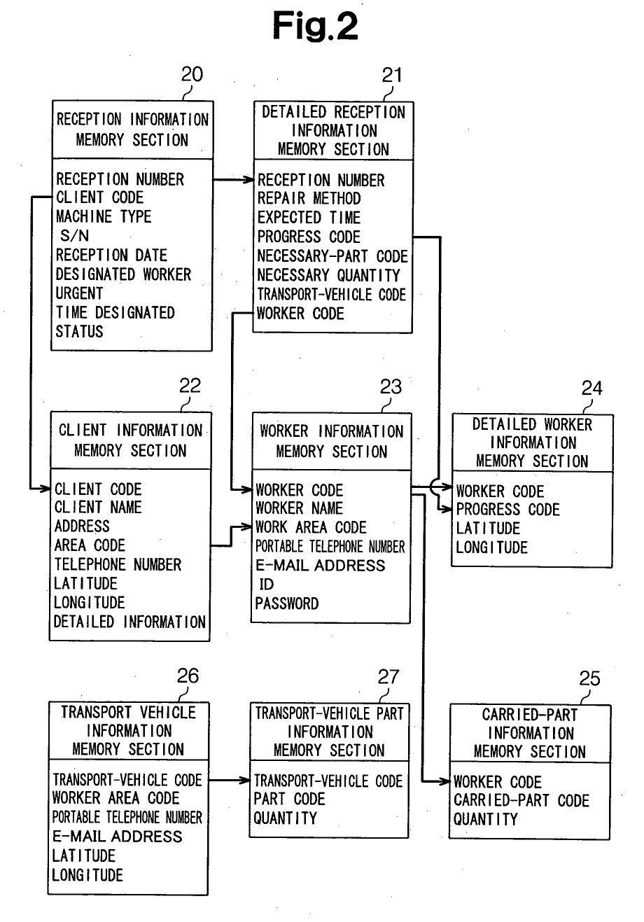

The data structures of the individual memory sections 20 to 27 will be discussed next with reference to FIG. 2.

Reception information, which has been input at the time a work request from a client is received, is stored in the reception information memory section 20 for each reception number. The reception information includes information on a reception number, a client code, a machine type, a serial number (S/N), a reception date, a designated worker, whether a task is urgent or not, a time designation and the state of a problem on the machine. The reception information has the reception number as an identifier.

Detailed reception information received from the failure diagnosis server 18 or the worker terminal 13 is stored in the detailed reception information memory section 21 for each reception number. The detailed reception information includes the reception number, a repair method, an expected time, a progress code, a necessary-part code and a necessary quantity as necessary-part information, a transport-vehicle code and a worker code as an identifier for a worker who takes charge of a task. The repair method, the expected time, the necessary-part code and the necessary quantity are discriminated and sent to the management server 11 by the failure diagnosis server 18. The repair method is a procedure for a task with respect to the work request and the expected time is the estimated time required for the task. The necessary-part code indicates the identifier of a part needed for a task and the necessary quantity indicates the quantity of parts needed for a task.

The transport-vehicle code is an identifier given to each transport vehicle and is used in case of transporting necessary parts by a transport vehicle. The progress code is an identifier indicating the progress of a task to be performed by the worker; for example, it is set to “00” as unaccepted, to “01” as in transit, to “02” as in progress, and to “03” as the completion of a task. The progress code is updated by a command sent from the worker terminal 13. The worker code is the code of the worker who has accepted a task. The detailed reception information has the reception number as an identifier and the reception number corresponds to the reception number of reception information.

Information about clients is stored in the client information memory section 22 client-by-client. The client information includes information relating to the location of a machine at the place of a client and the closing of a maintenance management contract with a client. The client information has already been stored in the client information memory section 22 before a repair request is received, and is updated every time a change is made when a work request is received. The client information includes a client code, a client name, an address, an area code, a telephone number, latitude, longitude, a contact state and so forth. The client code is used as an identifier for client information and corresponds to the client code stored in the reception information memory section 20. The area code is an identifier for an area which covers the address of the client.

Worker information about each worker is stored in the worker information memory section 23. The worker information includes a worker code, a worker's name, a work area code, the portable telephone number of the worker terminal 13, an e-mail address, and an ID and password needed at the time of accessing the management server 11. The work area code is used as an identifier for the area of which the worker is in charge and corresponds to the area code stored in the client information memory section 22. The ID and password are assigned to each worker. The worker code is used as an identifier for worker information.

Detailed worker information received from the worker terminal 13 or the like is stored in the detailed worker information memory section 24. The detailed worker information includes a worker code, a progress code, and latitude and longitude. The worker code is used as an identifier for detailed worker information and corresponds to the worker code stored in the worker information memory section 23. The progress code is an identifier indicating the progress state of a task and corresponds to the progress code in the detailed reception information memory section 21.

Carried-part information on parts carried by the worker is stored in the carried-part information memory section 25. The carried-part information includes a worker code, a carried-part code as an identifier for each part carried by the worker and the quantity of parts. The worker code corresponds to the worker code stored in the worker information memory section 23.

As the types of parts carried by the worker are determined, the carried-part information includes at least part codes relating to the determined parts. When the worker has used up a certain type of parts and the quantity of the parts becomes zero, a “0”, which means a quantity of zero, is input to the quantity data field corresponding to that carried-part code. It is to be noted that the carried-part code will not be deleted. When the worker newly receives parts which are other than those the worker was instructed to hold and which are sent by a transport vehicle or the like, part codes corresponding to the received parts are added to the carried-part code. The worker code is used as an identifier for carried-part information and corresponds to the worker code in the worker information memory section 23 and the detailed worker information memory section 24.

Transport-vehicle information about a transport vehicle or a person in charge of a transport vehicle is stored in the transport vehicle information memory section 26. The transport-vehicle information includes a transport-vehicle code, a work area code, the portable telephone number of the transport vehicle terminal 14 used by the transport person, an e-mail address, and the latitude and longitude of the transport vehicle. The transport-vehicle code is used as an identifier for transport-vehicle information.

Transport-vehicle part information on parts loaded on the transport vehicle is stored in the transport-vehicle part information memory section 27. The transport-vehicle part information includes a transport-vehicle code, a part code and the quantity of parts. The types of parts to be loaded on the transport vehicle are basically fixed. In the case where one type of parts are gone, a “0” is input to the quantity data field corresponding to that part code.

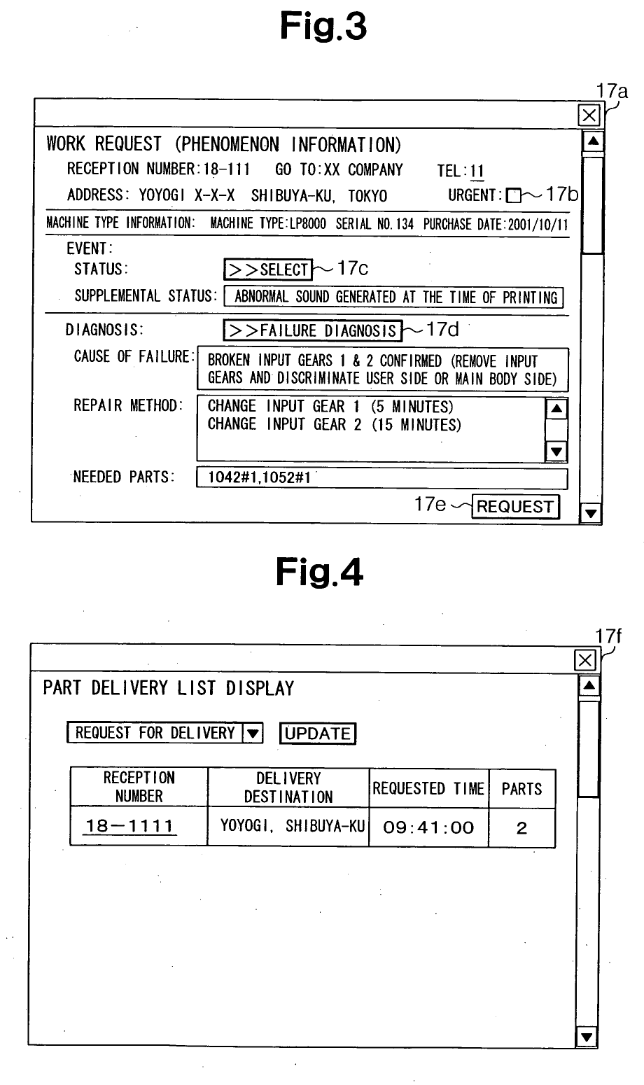

The following will discuss a work request screen 17a, which is displayed on the display section of the service department terminal 17 with reference to FIG. 3. The work request screen 17a displays part of the reception information, failure status information and diagnosis information. The reception information is displayed on the upper portion of the work request screen 17a. The reception information includes the reception number, the name and address of a client or a work site, and machine type information on a machine type in the order of left to right in FIG. 3. In the case where a task is urgent, a person in charge of reception (hereinafter called “receptionist”) or the like puts a check mark in an urgent check box 17b. Failure information about a problem on a machine reported by a client is displayed on a phenomenon display section positioned below the position where the reception information is displayed. On the phenomenon display section, the status of a failure can be selected from a list of failure statuses which are displayed on another screen by clicking a select button 17c or a failure status can be input in a status supplement field. FIG. 3 shows an example in which “abnormal sound generated at the time of printing” is input in the status supplement field. Depressing a failure diagnosis button 17d on a diagnosis display section located below the phenomenon display section sends the failure status information input on the phenomenon display section to the failure diagnosis server 18. The failure diagnosis server 18 conducts diagnosis upon reception of the failure status information, sends an inquiry for specifying a failure status, if needed, to the service department terminal 17 and receives a reply input by the receptionist or the like. The failure diagnosis server 18 sends the service department terminal 17 diagnosis information including the cause of a failure, a repair method, and the part codes and quantity of parts needed for the repair. This diagnosis information may be one piece or plural pieces for a single work request from a client. That is, the failure diagnosis server 18 extracts possible several failure causes from failure statuses received from a client, extracts the associated repair method or the like and sends them to the service department terminal 17. When the diagnosis information is displayed on the display section of the service department terminal 17 and a single piece of diagnosis information is settled by the receptionist, the settled diagnosis information is displayed on the diagnosis information display section of the work request screen 17a. The diagnosis information display section has a failure cause field, a repair method field and a necessary parts field. In FIG. 3, “broken input gears 1 & 2 confirmed” is displayed in the failure cause field. The repair method field shows “change input gear 1 (5 minutes)” and “change input gear 2 (15 minutes)”indicating the instruction on the repair method and the expected time for repair. The necessary parts field shows two display symbols “1042#1, 1052#1” each showing a part code and the quantity of the parts. When a request button 17e located at the lower portion of the work request screen 17a is clicked, diagnosis information is sent to the detailed reception information memory section 21 of the management server 11 and the diagnosis information in the detailed reception information memory section 21 is updated.

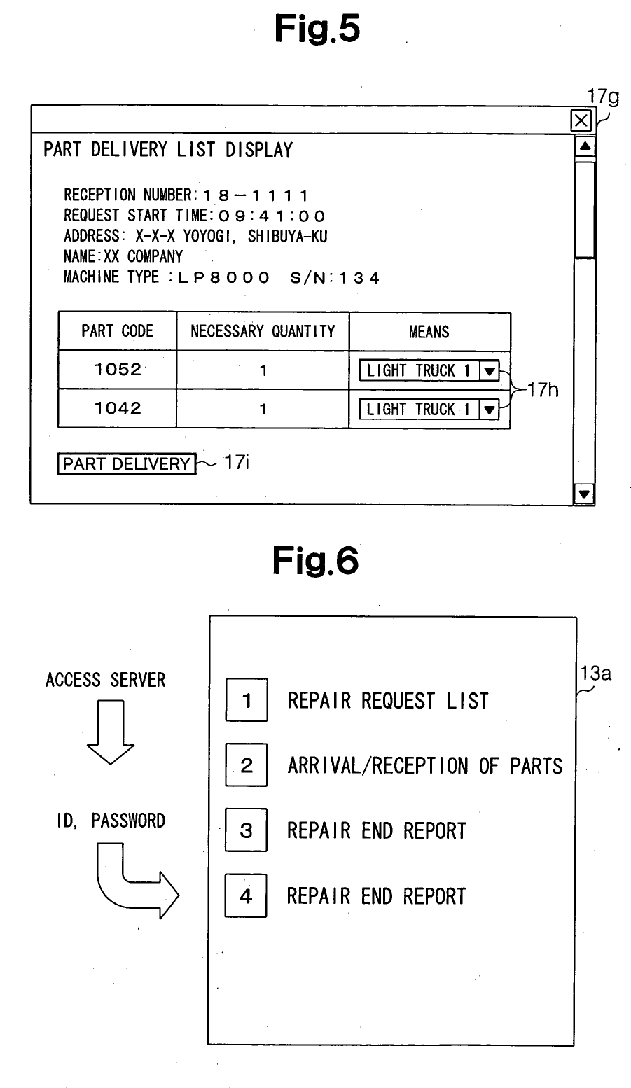

As described above, failure information is settled by the receptionist at the management center. In the case where parts are used in a repair, the work is displayed in the list for delivering parts on a part delivery list screen 17f in FIG. 4. The part delivery list shows the reception number of a work request, the place of delivery, a requested time and the quantity of parts. When the reception number displayed in the reception number field is selected, a part delivery screen 17g shown in FIG. 5 is displayed. The part delivery screen 17g shows reception information, including the reception number and the name of the client, and a means select field 17h for selecting means by which parts are to be delivered, the latter being for each part code. The means select field 17h shows at least one of a transport vehicle, worker and transport bike in the pull-down menu. The transport bike is always selectable from the means select field 17h in the case where parts need to be delivered urgently. FIG. 5 shows a light truck 1 or a transport vehicle which covers Shibuya-ku where the address of the client is located. In the case where parts which are not carried by the worker and are not loaded on a transport vehicle are needed, only a transport bike is displayed in the means select field 17h. When means for preparing parts is selected in the means select field 17h and a part delivery button 17i is pressed, e.g., in the case where the light truck 1 is selected, information on the address of the client, the part codes of necessary parts and the quantity of the parts is sent by e-mail to the transport vehicle terminal 14 carried by the transport person in charge of the light truck 1. Upon reception of the e-mail, the transport person goes to the place of the client by the light truck 1. In the case where the transport bike is selected, on the other hand, e-mail is sent to the transport bike terminal 15. Because parts are not loaded on the transport bike, the transport person receives parts from a parts manager or the like at the management center or parts warehouse and goes to the place of the client. It is sufficient that at least one transport bike is provided for the entire work area. In the case where a plurality of transport bikes are provided, their own coverage areas may be assigned.

Next, the display screen that is displayed on the display section of the worker terminal 13 will be discussed with reference to FIGS. 6 to 12.

When there is no accepted work remaining as in a case where all the tasks are finished, the worker uses the worker terminal 13 to access the management server 11 in order to receive a new task. The web server 16 in the management server 11 sends information of an initial screen for entering an ID and password to the worker terminal 13. The worker displays the initial screen on the display section of the worker terminal 13, inputs the ID and password and sends them to the management server 11. After verifying the ID and password, the management server 11 displays a menu screen 13a shown in FIG. 6 on the display section of the worker terminal 13 via the web server 16. The menu screen 13a shows menu items, “1 Repair Request List”, “2 Arrival/Reception of Parts”, “3 Repair End Report”, and “4 Technical Information”. As one of the menu items is selected, the next screen corresponding to that number is displayed.

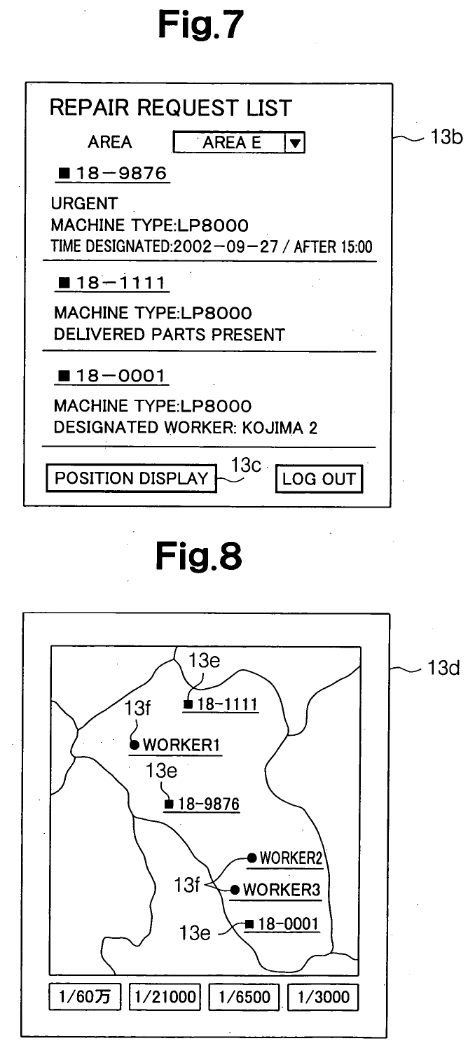

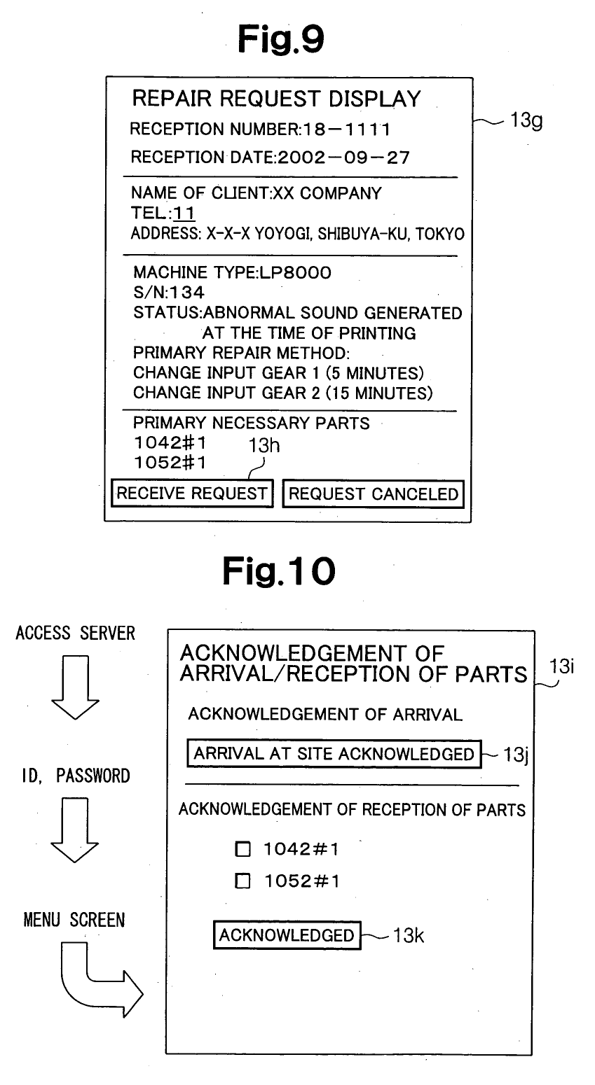

FIG. 7 shows a request list screen 13b which is displayed when the item “1 Repair Request List” in FIG. 6 is selected. Based on the ID of the worker already received, the work items in the coverage area of the worker corresponding to the ID is displayed on the request list screen 13b. FIG. 7 shows the work items of “Area E”. The reception number and machine type are shown in each work item in the request list, and the urgency, the designated time, whether or not there are parts to be delivered (not shown when there are none), the designated worker, etc. are displayed as needed. As the position display button 13c positioned at the lower position of the request list screen 13b is clicked, a map screen 13d in FIG. 8 is displayed. The map screen 13d shows a client position 13e and a position 13f for each worker in the area. The client position is indicated by the reception number and the position of each worker is indicated by a number assigned to that worker. Therefore, each worker can find out the distances between the place of the client and the other workers. As the worker presses a reception number in FIG. 8 or a reception number on the request list screen 13b in FIG. 7, the next screen showing information on the associated task is displayed. When the worker presses the reception number “18-1111” in FIG. 8, a request details screen 13g corresponding to the reception number “18-1111” and shown in FIG. 9 is displayed. The request details screen 13g shows the reception number, reception date, client information, information on the machine type or the like, the status of the machine when the request was made, a repair method for the machine status, an expected time for the repair, and parts needed for the repair. As apparent from the above, the worker selects a task to accept through the request details screen 13g in FIG. 9 and the map screen 13d in FIG. 8 in consideration of whether the task is urgent or not, whether there is a designated worker, the expected time, the machine type and the distance between the place of the client and the location of the worker, and so forth. When the worker presses a case reception button 13h, a progress update command as acceptance information is sent to the management server 11. Upon reception of the progress update command, the management server 11 sets the progress code in the detailed reception information memory section 21 which corresponds to the work item selected by the worker to “01” meaning “moving” and stores the worker code corresponding to the ID of the worker.

Referring to FIG. 10, a description will be given of the next screen which is displayed when the item “2 Arrival/Reception of Parts” is selected on the menu screen 13a in FIG. 6.

When arriving at the place of the client, the worker accesses the management server 11 to have the ID and password verified, and selects the item “2 Arrival/Reception of Parts” on the menu screen 13a. The management server 11 extracts the part code that corresponds to the ID previously transmitted, and extracts detailed reception information in which the worker code is stored and the progress code is set to “01” meaning “moving”. The management server 11 extracts necessary parts and necessary quantity and so forth from the detailed reception information and sends them to the worker terminal 13. The worker terminal 13 receives those pieces of information and displays an arrival report screen 13i shown in FIG. 10. When the worker presses a site-arrival acknowledge button 13j, the progress codes in the detailed reception information and the detailed worker information are set to “02” indicating “working”. In the case where there are parts delivered to the client's place by a transport vehicle or transport bike, the part codes of the delivered parts and the quantity of parts are displayed in the parts reception acknowledge field.

The worker checks if parts have arrived at the place of the client. When confirming the arrival of the parts, the worker puts check marks in the check boxes corresponding to the delivered parts. The worker presses a confirmation button 13k, confirms the selected parts being displayed on the next screen (not shown), then presses a transmission button (not shown). As a result, received-part information is sent to the management server 11. The management server 11 receiving the received-part information updates the carried-part information stored in the carried-part information memory section 25 and the transported-part information stored in the transport-vehicle part information memory section 27. In the case where the parts are delivered by the transport bike, the information in the carried-part information memory section 25 alone is updated and the information in the transport-vehicle part information memory section 27 is not. As the worker has received one “1042” and one “1052” in FIG. 10, the part codes and the quantities are added to the carried-part information and the quantities corresponding to “1042”and “1052” in the transported-part information are each decremented by one.

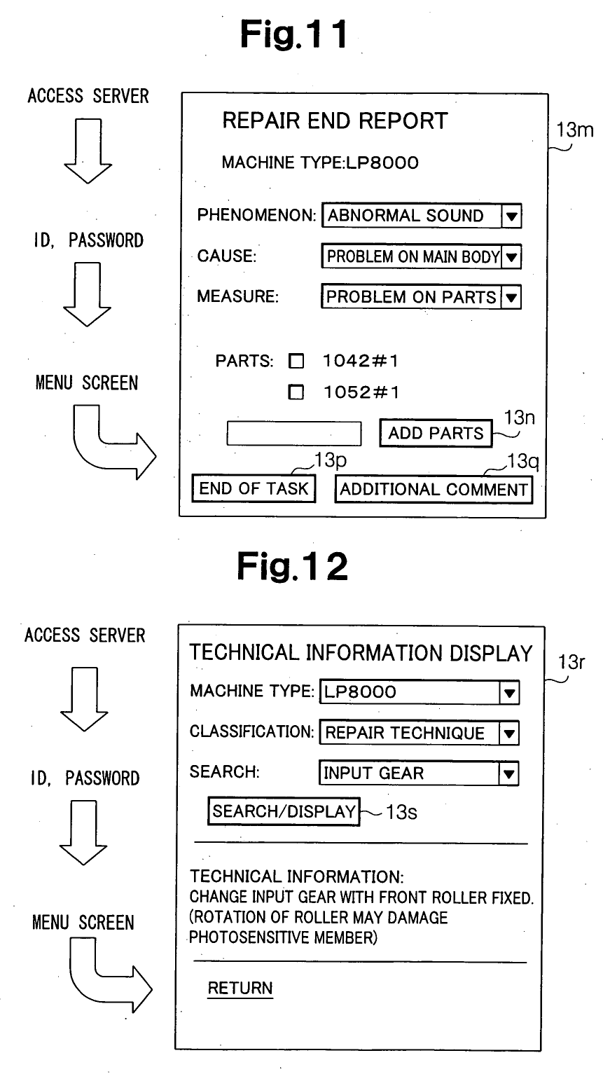

Referring to FIG. 11, a description will be given of the next screen which is displayed when the item “3 Repair End Report” is selected on the menu screen 13a in FIG. 6.

When a task is completed, the worker accesses the management server 11 to have the ID and password verified, and selects the item “3 Repair End Report” on the menu screen 13a. The management server 11 detects the worker code of the worker based on the ID already received. The management server 11 further searches the reception information and detailed reception information in which the worker code is stored and the progress code is set to “02” indicating “working” and extracts the machine type, necessary parts, the necessary quantity, etc. and sends those pieces of information to the worker terminal 13. The worker terminal 13 receives these pieces of information and displays an end report screen 13m on the display section. The end report screen 13m shows the fields of the “phenomenon” and “cause” of the failure, a selection field for the “measure” taken with respect to the failure, the part codes and quantity of the necessary parts, check boxes for them, etc. The worker selects the phenomenon of the machine that had a problem from the “phenomenon” select field. Next, the worker selects the cause of the problem from the “cause” select field, and selects the measure taken for the problem of the machine from the “measure” select field. Next, the worker selects parts used from the parts displayed and puts check marks in the corresponding check boxes. In this embodiment, the means by which the parts are delivered is not inquired of and the necessary-part codes and quantity in the detailed reception information are displayed directly. If there are other parts used, the worker inputs their part codes and presses an add parts button 13n to confirm their registration.

When finished with entering all the items, the worker selects a task end button 13p. As the task end button 13p is selected, a progress update command as task end information and a signal relating to used-part information are sent to the management server 11 and the progress code of the worker is set to “03” indicating the end of the task. Information on the phenomenon, etc. input on the end report screen 13m is sent to the failure diagnosis server 18. Further, the carried-part information stored in the carried-part information memory section 25 is updated with the used-part information. When the worker presses an additional comment button 13q, the next screen (not shown) is displayed on which the worker can input communication notes, such as the necessity for revisiting.

Referring to FIG. 12, a description will be given of the screen which is displayed when the item “4 Technical Information” is selected on the menu screen 13a in FIG. 6.

When there is technical information the worker wants to check, the worker accesses the management server 11 to have the ID and password verified, and selects the item “4 Technical Information” on the menu screen 13a. When the item “4 Technical Information” is selected, a technical information screen 13r shown in FIG. 12 is displayed on the display section of the worker terminal 13. The technical information screen 13r shows a “machine type” select field, a “classification” select field, a “search word” input field and a search/display button 13s. As the worker selects or inputs items to be searched through those fields and selects the search/display button 13s, a work-technique information request signal is sent to the failure diagnosis server 18. In the case where there is work technique information in the failure diagnosis server 18, the work technique information is displayed under the search/display button 13s.

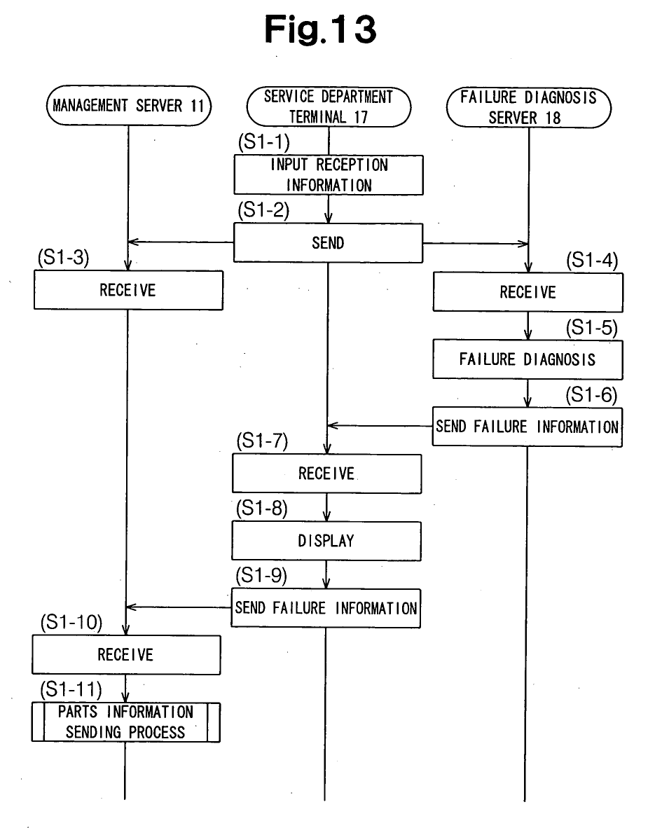

Various procedures for assisting the work of a worker in the worker assisting method provided by the management server 11 will be discussed below with reference to flowcharts in FIGS. 13 to 17. First, a procedure for preparing parts necessary for a task upon reception of a work request from a client will be discussed with reference to FIG. 13.

The receptionist posted at the management center receives a work request via a client code by telephone, e-mail or the like. This work request is made when a machine already at a work site has a problem. The receptionist acquires information on the client code or client name, the machine type of the machine, the serial number, a failure status and so forth from the client and inputs the information into the service department terminal 17. Further, the receptionist inputs reception information on the reception number, the reception date, and whether or not the task is urgent, the time designation and designation of a worker, as needed, into the service department terminal 17 in step S1-1. When the reception information is input to the service department terminal 17, the service department terminal 17 sends the reception information to the management server 11 and the failure diagnosis server 18 in step S1-2. In step S1-3, the management server 11 receives the reception information from the service department terminal 17 and stores the reception information in the reception information memory section 20. In step S1-4, the failure diagnosis server 18 receives the reception information from the service department terminal 17 and then advances the flow to step S1-5. In step S1-5, the failure diagnosis server 18 performs failure diagnosis based on the reception information. Through the failure diagnosis, failure information such as the cause, repair method, parts needed for the repair, the expected time for the repair and so forth is output and the flow proceeds to step S1-6. In step S1-6, the failure diagnosis server 18 sends the failure information to the service department terminal 17. As there are normally plural possible causes, a plurality of repair methods are proposed for this failure information. Next, in step S1-7, the service department terminal 17 receives the failure information and advances the flow to step S1-8. In step S1-8, the service department terminal 17 displays plural pieces of failure information on the display section. The receptionist or the like selects that failure information of the displayed plural pieces of failure information that is the most likely one. With the failure information settled, the service department terminal 17 sends the selected failure information to the management server 11 in step S1-9. In step S1-10, the management server 11 receives the failure information and stores the reception number, the repair method, the expected time, the necessary-part code and the necessary quantity in the detailed reception information memory section 21. In the next step S1-11, the management server 11 performs a process for sending parts information.

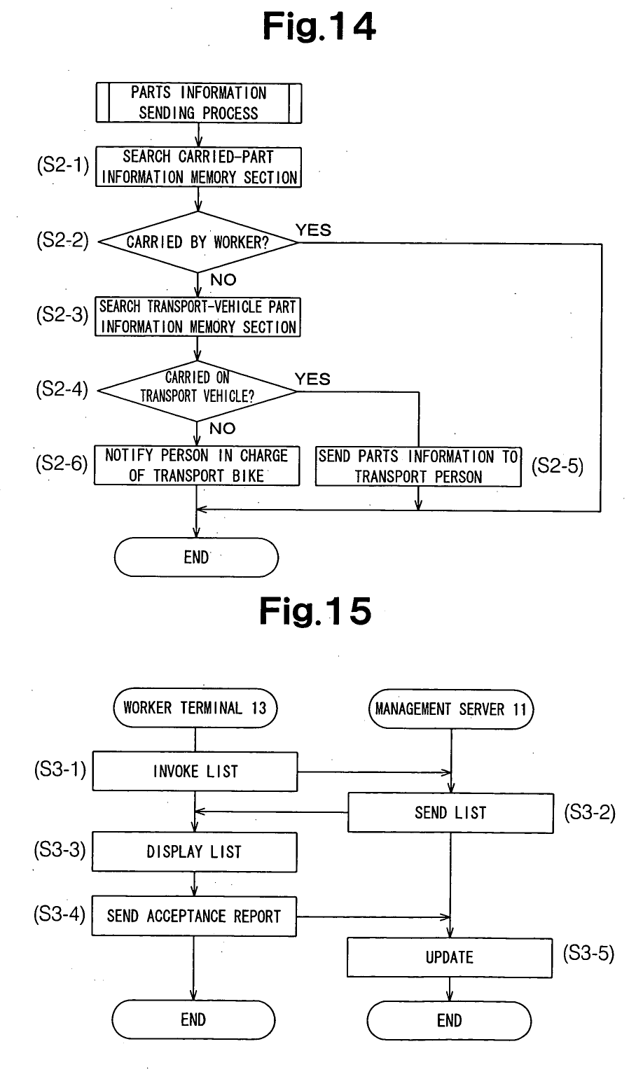

Next, the parts information transmission process will be described with reference to FIG. 14. In step S2-1, the management server 11 searches carried-part information stored in the carried-part information memory section 25 for the worker who takes charge of an area including the address of the client to thereby check if the necessary part is of the type of a part carried by the worker. In the next step S2-2, the management server 11 determines whether or not the part is what is carried by the worker.

In the case where the result of the decision in step S2-2 is YES, i.e., when there is a part of the same part code, the management server 11 decides that one of the workers has that part, outputs a display showing the worker in the means select field 17h of the part delivery screen 17g and terminates the process. In the case where the result of the decision in step S2-2 is NO, on the other hand, i.e., when there is no part of the same part code, the management server 11 detects an area code from the address of the client and selects the transport vehicle that covers the area to determine whether or not the necessary part is on the transport vehicle. Then, the management server 11 searches the transport-vehicle part information memory section 27 to check if there is the same part code as the necessary-part code stored in the detailed reception information memory section 21. In the case where there is transport-vehicle part information which has the same part code, it is checked to determine if the quantity stored in the transport-vehicle part information satisfies the quantity of necessary parts in the detailed reception information memory section 21, and the flow proceeds to step S2-4. In step S2-4, the management server 11 determines whether or not the transport vehicle carries the necessary quantity of necessary parts. When the result of the decision in step S2-4 is YES, i.e., when the transport vehicle carries the necessary parts, the transport vehicle is displayed in the means select field 17h of the part delivery screen 17g. When the transport vehicle is selected from what is displayed in the means select field 17h, the management server 11 advances the flow to step S2-5. In step S2-5, the management server 11 sends information including the necessary-part code, the necessary quantity, and the name and address of the client to which the parts are to be delivered to the transport vehicle terminal 14 of the selected transport vehicle, then terminates the process. At this time, the transport-vehicle code of the transport vehicle to deliver the parts is stored in the detailed reception information. The transport person delivers the parts corresponding to the necessary-part code to the client's place according to the received information. When the result of the decision in step S2-4 is NO, on the other hand, i.e., when the transport vehicle does not carry the necessary parts, the management server 11 sends the transport bike terminal 15 information including the necessary-part code, the necessary quantity and the name and address of the client which is the delivery destination of the parts. The person who takes charge of a transport bike receives those parts at the management center or the parts warehouse and delivers them to the client's place. At this time, the identifier of the transport vehicle is stored in the detailed reception information.

A procedure for the worker to accept a task will be discussed with reference to FIG. 15.

In the case where the worker has no further tasks of which the worker has taken charge, the worker accesses the management server 11 using the worker terminal 13. The management server 11 verifies the ID and password via the web server 16 and displays the menu screen 13a in FIG. 6 on the worker terminal 13. When the worker selects the “1 Repair Request List” on the menu screen 13a, the worker terminal 13 sends a command to invoke a list to the management server 11 in step S3-1. Based on the ID of the worker, the management server 11 extracts the work request items for the area for which the worker takes charge from the reception information memory section 20. Of the detailed reception information corresponding to the extracted work request items, that detailed reception information in which the progress code is set to “00” or set to “unaccepted” and the work request items which correspond to that information are further extracted. In step S3-2, the management server 11 sends the work request list to the worker terminal 13. In step S3-3, the worker terminal 13 displays the work request list from the management server 11. The worker selects the work request items from the work request list in accordance with whether or not the machine type can be handled, whether or not the task is urgent, and whether or not there is a designated worker, and views the request details screen 13g in FIG. 9. As needed, the worker presses the “position display” button 13c on the request list screen 13b in FIG. 7 to display the map screen 13d in FIG. 8, and checks the place of the client to visit and the worker's own position. At the time of selecting the work request items, therefore, the worker can take the distance between the worker's present position and the client's place into account. Next, the flow proceeds to step S3-4. In step S3-4, when the worker selects the work request items and presses the case reception button 13h on the request details screen 13g, the progress update command as acceptance information is sent to the management server 11. The management server 11 receives the progress update command and sets the progress code in the detailed reception information to “01” indicating “moving”, stores the code of the worker in the worker code, and then updates the detailed reception information memory section 21 in step S3-5.

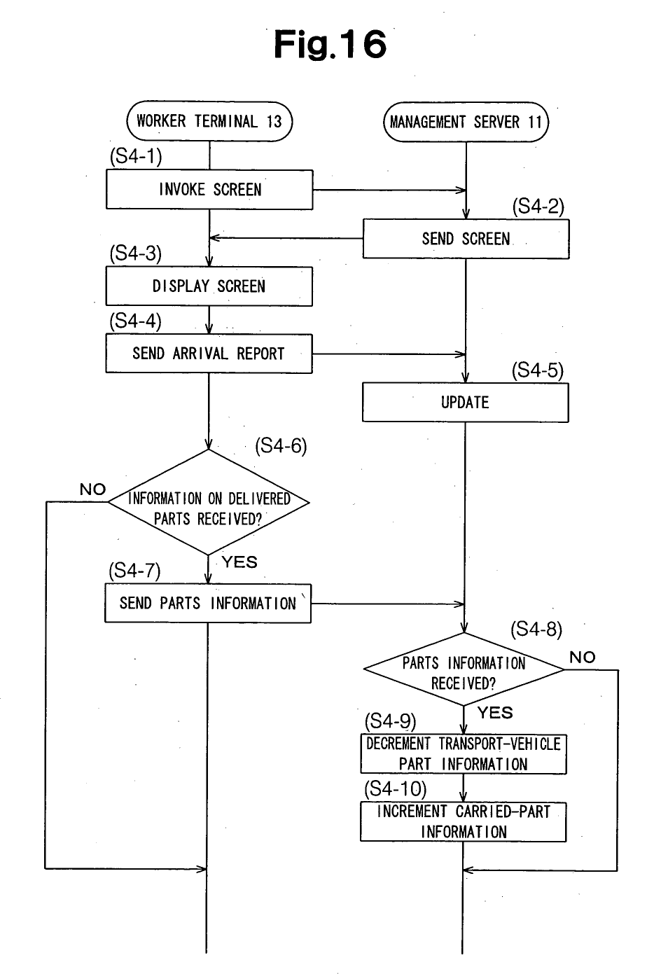

Next, a procedure for executing an arrival report, which is carried out when the worker arrives at the client's place, will be discussed with reference to FIG. 16 together with FIG. 10. The worker accesses the management server 11 using the worker terminal 13. In step S4-1 in FIG. 16, the worker terminal 13 has the ID and password verified via the web server 16 of the management server 11 and invokes the case reception button 13iin FIG. 10. The management server 11 sets the progress code to “01” (“moving”) and extracts the detailed reception information in which the worker code corresponding to the ID of the worker is stored. In the next step S4-2, when the transport-vehicle code or the identifier of the transport bike is stored in the extracted detailed reception information, the management server 11 sends information on the necessary-part code, necessary quantity, etc. to the worker terminal 13. The worker terminal 13 displays the site-arrival acknowledge button 13j in FIG. 10 and the case reception button 13i showing the part code and quantity of the delivered parts in step S4-3. Then, the worker presses the site-arrival acknowledge button 13j. Consequently, the worker terminal 13 sends the progress update command to update the progress code to “02” or “working” to the management server 11 in step S4-4. Upon reception of the progress update command, the management server 11 sets the progress code to “02” and updates information in the detailed reception information memory section 21 and the detailed worker information memory section 24 in step S4-5.

Next, in step S4-6, the worker terminal 13 determines whether or not information on the delivered parts is received. When the result of the decision in step S4-6 is NO, i.e., when the delivered-part information has not been received, the worker terminal 13 terminates the process right away. When the result of the decision in step S4-6 is YES, on the other hand, i.e., when the delivered-part information has been received, the worker checks the part code and quantity of the parts, delivered to the client's place, on the case reception button 13i shown in FIG. 10. Then, the worker puts check marks in the check boxes corresponding to the parts displayed in the parts reception acknowledge field and presses the confirmation button 13k. As a result, the worker terminal 13 sends the received-part information to the management server 11 in step S4-7. In the case where no check marks are put in the check boxes even if parts information is received, a message like “no parts need to be delivered?” may be displayed. Meanwhile, the management server 11 determines in step S4-8 whether or not the received-part information has been received. When the result of the decision in step S4-8 is YES, i.e., when the received-part information has been received, the management server 11 advances the flow to step S4-9. In step S4-9, the management server 11 subtracts the part quantity in the transport-vehicle part information which corresponds to the parts received by the worker, determining that the number of the parts loaded on the transport vehicle is therefore decreased. In the case where the part code of the received parts is not present in the transport-vehicle part information at this time, they are delivered by the transport bike so that the management server 11 does not update the part quantity. Further, in step S4-10, the management server 11 concludes that the parts carried by the worker are increased and increments the number of received parts in the carried-part information. When the result of the decision in step S4-8 is NO, on the other hand, i.e., when the received-part information is not received, the management server 11 terminates the process.

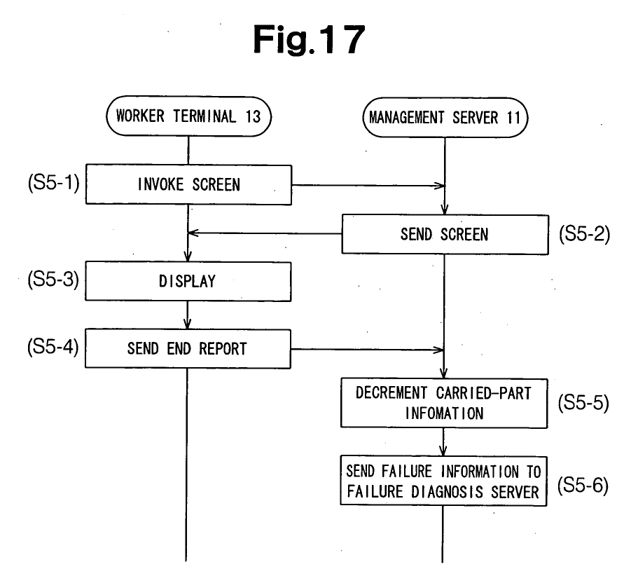

Next, a procedure for making a task end report when the worker finishes the task will be discussed with reference to FIG. 17 together with FIGS. 6 and 11. When the task is completed, the worker accesses the management server 11 using the worker terminal 13. Then, the worker has the ID and password verified by the management server 11 via the web server 16. The worker selects the item “3 Repair End Report” on the menu screen 13a shown in FIG. 6 sent from the web server 16. Then, the worker terminal 13 sends a command to invoke the end report screen 13m to the management server 11 in step S5-1. The management server 11 sets the progress code to “02” or “working” and extracts information on the necessary parts and necessary quantity in the detailed reception information in which the worker code corresponding to the received ID is stored and information on the machine type, etc. included in reception information corresponding to this detailed reception information.

Then, the management server 11 sends information for displaying a screen to make an end report to the worker terminal 13 in step S5-2. In step S5-3, the worker terminal 13 displays the end report screen 13m in FIG. 11. The worker inputs the phenomenon and cause of the problem, and the measure taken for the problem in the end report screen 13m and puts check marks in the check boxes corresponding to the parts used. Further, as the worker presses the work end button 13p, the worker terminal 13 sends the work progress update command and the end report which is used-part information to the management server 11 in step S5-4. The management server 11 sets the progress codes in the detailed reception information memory section 21 and the detailed worker information memory section 24 to “03” meaning the end of the task. Then, in step S5-5, the management server 11 decrements the number of used parts from the carried-part information, concluding that the worker has used parts carried with him. Even when parts are delivered separately by a transport vehicle or the like, the number of received parts is incremented in the carried-part information at the time the arrival report is made, so that the quantity in the carried-part information is decremented at the time of making the end report. Further, the management server 11 sends the cause and the processing method to the failure diagnosis server 18 in step S5-6.

This embodiment has the following advantages.

The worker can receive the work request list from the management server 11, select a work request item from the list and accept the next task himself or herself. Unlike the prior art, therefore, the embodiment makes it unnecessary for the worker to create the worker's own work schedule and can thus reduce the burden on the work manager at the management center. Alternatively, it is unnecessary to post a work manager at the management center.

The work request list shows the machine type, whether or not the work is urgent, whether or not there is a designated worker, and so forth. Therefore, the worker can select the next task in consideration of this information, and can efficiently proceed with work. The work request list is generated by extracting a work request item whose progress code in the detailed reception information memory section 21 is set to “00” or “unaccepted”. This makes it possible to prevent erroneous entry of work items, such as double acceptance of work items.

The failure diagnosis process outputs failure information such as the repair method, parts needed for the repair, the cause and the expected time for the repair. In the case where a part needed for the repair is of the type which is not carried by the worker and is loaded on a transport vehicle, information such as the part code, the quantity and the address of the client is sent to the transport vehicle terminal 14. In the case where a part needed for the repair is of the type which is not carried by the worker and is not loaded on a transport vehicle, information on a part to be delivered is sent to the transport bike terminal 15 by e-mail. This can allow a transport vehicle or bike to efficiently deliver parts to the place of the client. Therefore, each worker need not manage parts, thus reducing the burden on the worker. In the case where parts needed for repair are small, a worker carries them. For small parts, it is therefore unnecessary to deliver the parts by a transport vehicle and parts carried by the worker himself or herself are used. It is therefore possible to efficiently manage parts.

The map screen 13d in FIG. 8 showing the latitude and longitude, the latitude and longitude of the address of a client, the position of the worker and the position of the client, acquired by the GPS function of the worker terminal 13 can be displayed on the display section of the worker terminal 13. Accordingly, the worker can select a task to accept next in consideration of the distance between the client's place and the worker.

The management server 11 sends the worker terminal 13 only a work request item with the progress code set to “00”, i.e., unaccepted item, for an area of which the worker is in charge. This can prevent erroneous entry of work items, such as double acceptance of work items.

The acceptance update command sent at the time an acceptance report is made from the worker terminal 13 sets the progress code to “01”, i.e., “moving”. Therefore, the worker can discriminate if a work item in question is accepted by searching the progress codes in the detailed reception information memory section 21. The acceptance update command causes the worker code of the worker who has accepted a task to be stored in the detailed reception information. This makes it possible to discriminate a worker who has accepted a work request item.

When the worker arrives at the place of the client, the worker terminal 13 sends the part codes and quantity of parts delivered to the client's place to the management server 11. In the case where parts received at the client's place are what has been delivered by a transport vehicle, the management server 11 decrements the number of parts stored in the transport-vehicle part information memory section 27 and increments the number of parts stored in the carried-part information memory section 25. This can ensure efficient management of parts.

When the worker arrives at the place of the client, the worker terminal 13 sends the management server 11 a command to set the progress code in the detailed reception information to “02”, i.e., “working”. It is therefore possible to discriminate a work item the worker has started doing by searching the progress codes in the detailed worker information memory section 24.

At the time of reporting the end of a task, the management server 11 extracts necessary parts to be used and the necessary quantity and sends those pieces of information to the worker terminal 13. The worker receives information on parts to be used through the worker terminal 13 and selects information corresponding to used parts. At this time, the management server 11 decrements the number of parts carried by the worker. This can ensure efficient management of parts.

The management server 11 sends the worker terminal 13 the end report screen 13m showing the phenomenon and cause of the problem of a machine, the measure select field, and the part codes and quantity of parts to be used. The worker inputs the phenomenon, the cause, the measure taken for the problem, etc., puts check marks in the check boxes corresponding to the parts used, and sends information on the repair to the management server 11. Those pieces of information can therefore be stored in the failure diagnosis server 18 as failure information.

At the time of reporting the end of a task, the worker can set the progress code to “03”, i.e., “the end of the task”, by the progress update command which is sent to the management server 11 using the worker terminal 13. Therefore, a task-completed item can be discriminated by searching the progress codes in the detailed reception information memory section 21 and the detailed worker information memory section 24.

The technical information screen 13r showing technical information needed for a task is displayed on the worker terminal 13 (see FIG. 12). While working or the like, therefore, the worker can easily acquire information needed for the work. The worker can thus proceed with the work efficiently.

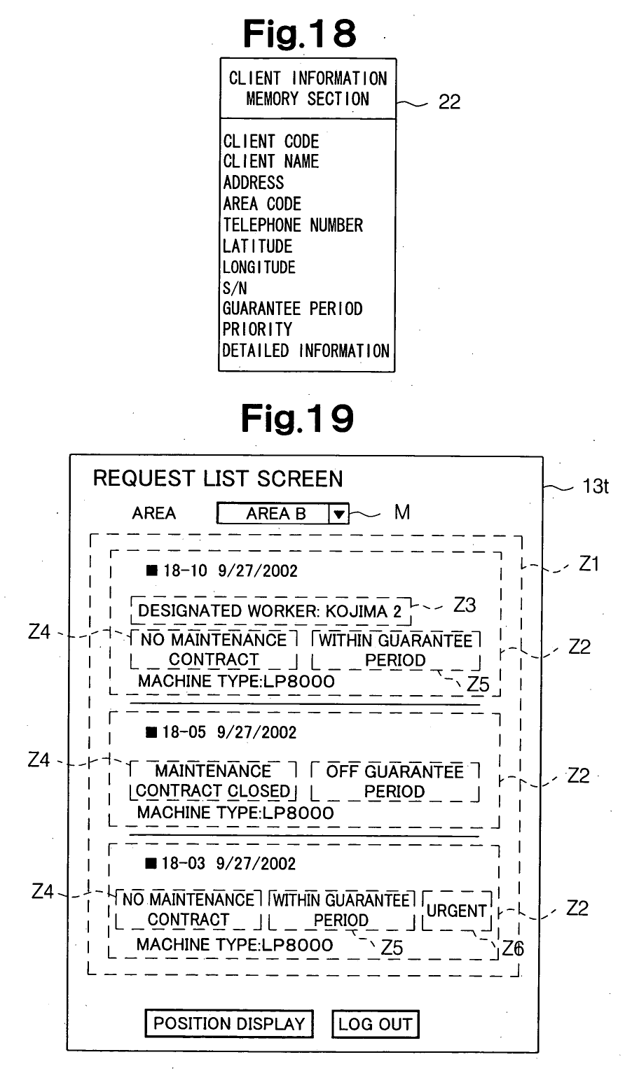

A description will now be given of the second embodiment of the present invention with reference to FIGS. 18 and 19. As this embodiment has the structure of the worker assisting system according to the embodiment in FIGS. 1 to 17 which is partly modified, detailed descriptions of similar portions will not be given below.

As shown in FIG. 18, client information is stored client-by-client in the client information memory section 22 provided in the management server 11. The client information in this embodiment includes the serial number (S/N), the warranty period and the priority in addition to the client information of the embodiment in FIGS. 1 to 17. The serial number is the serial number of a machine located at the place of the client. In the case where plural machines to be targets for maintenance are located at the place of the client, for example, a plurality of serial numbers and a plurality of warranty periods are included in the client information. The warranty period indicates the period for a machine to be a target for maintenance.

Next, the process by which the management server 11 sends information on an unaccepted work item will be discussed with reference to FIG. 15. In step S3-1, when the worker terminal 13 sends a command to invoke a list to the management server 11, the management server 11 extracts reception information for the unaccepted work item in the area which is covered by the worker from the reception information memory section 20 based on the ID of the worker. Or, the management server 11 receives an area designating command sent together with the invoking command and extracts an unaccepted work item in the area corresponding to the area designating command from the reception information memory section 20. The area designating command is sent to the management server 11 from the worker terminal 13 in the case where the worker has selected an area in an area select field M on a request list screen 13t (to be discussed later) shown in FIG. 19.

After extracting the reception information of unaccepted work items from the reception information memory section 20, based on the previously received ID of the worker, the management server 11 checks if there is a work item for which the worker is designated. Specifically, the management server 11 checks if the name or identifier of the designated worker is stored in the reception information of the extracted work item. In the case where there is reception information in which a worker is designated, the order of that reception information is set the highest.

Further, the management server 11 ranks the reception information of other unaccepted work items based on the priority of the individual clients and whether or not the task is urgent, and arranges the individual items according to the ranking. Specifically, the management server 11 searches the client information memory section 22 and extracts the priority according to whether or not there is a maintenance contract from the client information corresponding to the extracted work item. In this embodiment, the priority is defined as high when there is a maintenance contract and as low when there is not. Based on the priority, the management server 11 arranges the work items, separating them from those with a maintenance contract (high priority) and those without it (low priority). In the individual items with high priority and the individual items with low priority, the management server 11 sorts the items based on whether or not the items are urgent. Urgent items are ranked high. The management server 11 sorts the individual items in the order of items with high priority and urgent, items with high priority and not urgent, items with low priority and urgent and items with low priority and not urgent.

After arranging the items, the management server 11 sends the work request list with the sorted items to the worker terminal 13 (see step S3-2 in FIG. 15). Upon reception of the work request list, the worker terminal 13 displays the list on the display section (see step S3-3 in FIG. 15). Referring to FIG. 19, a description will now be given of the request list screen 13t which is displayed on the display section of the worker terminal 13 at this time. Work items requested by clients in each area are shown on the request list screen 13t. The request list screen 13t also shows the area select field M and when this area select field M is selected, individual area names are shown in the pull-down menu. As one area name is selected from the pull-down menu, the worker terminal 13 sends the aforementioned area designating command to the management server 11.

The request list screen 13t is provided with a list display region Z1. Work-item display regions Z2 are displayed, work-item-by-work-item, in the list display region Z1. Each work-item display region Z2 shows the reception number and the reception date. In the case where a worker is designated, the associated work item is set to the highest order by the management server 11. Therefore, the work-item display region Z2 which includes a designation display section Z3 where the name of a designated worker is shown is displayed topmost. The work item for which a worker is designated, is displayed on the worker terminal 13 for that worker only when the designated worker accesses the management server 11. That is, in the case where the management server 11 verifies the ID of a worker other than a designated one, even if there is a request designating a worker, the designation display section Z3 does not show information on that request.

Each work-item display region Z2 is provided with a contract display section Z4. The contract display section Z4 shows the client who has requested the work item and whether a maintenance contract is closed or not. The management server 11 places those work items which are requested by clients who have closed maintenance contracts, at a high rank and arranges the individual items according to the ranking. Therefore, the work-item display region Z2 which shows a work item with a maintenance contract is displayed under the work-item display region Z2 which includes the designation display section Z3.

Each work-item display region Z2 shows a warranty display section Z5. The warranty display section Z5 shows whether the warranty period for a machine which is a target for the work request is valid or not. The worker checks if the warranty period is valid or not, and determines the charge for the task. In case the task is urgent, an urgency display section Z6 is provided to permit the worker to see if the task is urgent, as shown in the work-item display region Z2 at the bottommost position in FIG. 19. Because the management server 11 ranks urgent items higher in both the items with a maintenance contract and the items without a maintenance contract, though not shown in FIG. 19, urgent items are displayed above non-urgent items. In addition, the work-item display region Z2 shows the machine type or so of the machine which is the work target.

As apparent from the above, the individual work items arranged and displayed on the request list screen 13t by the management server 11 are sorted in such a way that an item which should be handled sooner by priority by the worker is displayed higher in the request list screen 13t. Therefore, the worker views the request list screen 13t and accepts a work item displayed higher by priority over one displayed lower. That is, the worker selects the work request item displayed topmost and selects the case reception button 13h on the request details screen 13g shown in FIG. 9. Then, the worker terminal 13 sends the progress update command as acceptance information, reporting the acceptance to the management server 11 (see step S3-4 in FIG. 15). Upon reception of the progress update command, the management server 11 updates information in the detailed reception information memory section 21 (see step S3-5 in FIG. 15).

The second embodiment has the following advantages in addition to the advantages of the first embodiment in FIGS. 1 to 17.

Information which indicates the priorities of clients is stored in the client information memory section 22. The management server 11 generates a list by arranging information on unaccepted work items for each area based on information on the priorities of the clients and information on whether each work item is urgent or not. The individual work items are displayed on the display section of the worker terminal 13, which has received the list, in such a state that they are arranged based on the priorities and whether the individual work items are urgent or not. As this system can allow each worker to determine which one of the arranged items has the highest priority over the other, the worker can surely accept a work item which should be taken care of first.

In the embodiment, the management server 11 may only rank the priorities of work items and the worker terminal 13 may arrange the work items according to priority. In this case, the worker terminal 13 has a display section, and a button or so forth for arranging the work items. A worker arranges the individual work items by operating the display section. Alternatively, the display section displayed on the worker terminal 13 may show the order.

A description will now be given of the third embodiment of the present invention. As the structure of this embodiment is just a partial modification of the structure of the worker assisting system according to the embodiment in FIGS. 1 to 17, detailed descriptions of similar portions will be omitted.

The management server 11 in this embodiment is a system which is shared by a plurality of business entities in different business fields, such as a business entity which repairs and maintains printers, a business entity which delivers consumables like toner, and a business entity which collects products at the places of clients. Therefore, the management server 11 has reception information memory sections 20 corresponding to the individual business entities. Worker codes stored in the worker information memory section 23 are data capable of identifying the business entities. Note that consumables correspond to parts.

A business entity which delivers consumables does not have workers posted but has only transport persons in charge of their respective areas. Therefore, a transport person has the worker terminal 13 and the transport vehicle terminal 14 or has a terminal provided with the capabilities of the terminals 13 and 14. Further, in this case, the terminal carried by the transport person reports acceptance of a work item, the end of a task and so forth to the management server 11 when operated by the transport person, but does not command the execution of failure diagnosis or report received parts.

Because a business entity which collects products at the places of clients does not need to deliver goods or the like to the places of clients, it does not have goods, such as parts and consumables beforehand. Therefore, the collecting entity need not post transport persons who deliver parts and so forth to the places of clients. In this case, the worker terminal 13 reports acceptance of a work item, the end of a task and so forth when operated by a worker, but does not command the execution of failure diagnosis or report received parts.

At the time each worker terminal 13 accesses the management server 11, the management server 11 specifies a company to which the worker carrying the worker terminal 13 belongs based on worker information using the ID sent from the worker terminal 13. Further, the management server 11 searches the reception information memory section 20 corresponding to the specified company to extract unaccepted reception information and performs the above-described processes.

The third embodiment has the following advantages in addition to the advantages of the first embodiment in FIGS. 1 to 17.

The management server 11 is provided with a plurality of reception information memory sections 20 classified company-by-company, and a company is specified by a worker code stored in worker information in the worker information memory section 23. Accordingly, the management server 11 can serve as a system which is shared by a plurality of business entities or workers classified into a plurality of categories.

The embodiment may be modified as follows.

Output means, such as a printer, may be connected to the transport vehicle terminal 14 so that at the time of delivering parts, an estimate or a bill can be output using information on parts sent to the transport vehicle terminal 14. This method makes it unnecessary for a worker to generate an estimate or a bill, thus reducing the burden on the worker.

Output means, such as a printer, may be connected to the worker terminal 13 so that an estimate or a bill can be output using information on parts sent to the worker terminal 13. This method can allow a worker to easily generate an estimate or a bill.

In the case where a worker does not have parts necessary for a task when accepting the work, the worker may notify the management center of this fact. At this time, the management center sends information for delivery of the parts to the transport vehicle terminal 14 of a transport vehicle that can deliver the parts to the place of the client. In the case where parts necessary for a task are not those which are loaded on a transport vehicle, the management center sends information for delivery of the parts to the transport bike terminal 15. At this time, the same type of parts as parts carried by a worker may be loaded on a transport vehicle. This method delivers parts needed for a task at the time a worker accepts the work but does not deliver parts needed for an unaccepted task, and thus can ensure relatively efficient delivery of parts.

The worker terminal 13 need not be a portable telephone but can be any type of terminal which can receive and display information sent from the management server 11 and the web server 16, has the ability to send information to the management server 11 and has the GPS functionality. The worker terminal 13 may be a PDA (Personal Digital Assistant) or a notebook type personal computer, for example. A worker may separately carry both a terminal having the GPS functionality and a terminal that displays received information.

The transport vehicle terminal 14 need not be a portable telephone but can be any type of terminal which can receive and display information sent from the management server 11 and has the GPS functionality. The transport vehicle terminal 14 may be a PDA or a notebook type personal computer, for example. A transport person may separately carry both a terminal having the GPS functionality and a terminal that displays received information. In addition, the transport vehicle terminal 14 need not be portable.

The management server 11 and the Web server 16 may be provided separately. This system can reduce the load on the management server 11.

A receptionist or the like at the management center may retrieve the cause of a problem, a repair method and necessary parts using a data base where failure information including causes and repair methods and parts necessary for repairs are stored.

A plurality of transport vehicles may drive around or stand by in a work area. In this case, the management server 11 selects that transport vehicle which is located closest to the place of a client from the latitudes and longitudes of individual transport vehicles detected by position detecting means and the latitude and longitude of the client. This method can deliver parts quickly to the place of the client.

A client may access the failure diagnosis server 18 over a network (not shown) such as the Internet and do failure diagnosis using individual screens displayed on the terminal used by the client based on information sent from the failure diagnosis server 18. In the case where the failure diagnosis indicates the need for a repair by a worker, a work request is sent. The work request is received by the management server 11 and stored in the reception information memory section 20 and the detailed reception information memory section 21. This method can reduce the burden on the receptionist or the like.

The management server 11 may store a conversion table containing information on availability, such as whether the required parts are loaded on a transport vehicle or are of the type carried by a worker.

A required skill indicating the level of the technical ability required for a task which has been determined by the failure diagnosis server 18 may be stored in the detailed reception information memory section 21. This method can permit a worker to select work request items according to the required skills shown on the request list screen 13b or so. At this time, information on the skill indicating the level of the technical ability of a worker may be stored in the detailed worker information memory section 24 and only information on a work request the required skill for whose item is met by the skill of the worker may be sent to the worker terminal 13. This method can permit a worker to relatively easily select a task to accept next.

Information of machine types for which a worker takes charge may be stored in the detailed worker information memory section 24 and work request items for machines the worker can handle may be sent to the worker terminal 13 based on the information on the covering machine types. This method can permit a worker to relatively easily select a task to accept next.

The system may be modified in such a way that selecting a number assigned to each worker displayed on the map screen 13d in FIG. 8 displays the progress status on the display section of the worker terminal 13 based on the worker code and name of the worker and the progress code stored in the detailed worker information for the worker. This method can allow the progress statuses of other workers to be used as data for the decision to select the next task so that a task can be selected appropriately.

A map file that shows the places of clients whose requests were received and the positions of workers may be displayed on the service department terminal 17 for each work date. Further, a map file may show the position of a transport vehicle. This method can allow the receptionist, a work manager and so on posted at the management center to grasp the distance between the position of a worker and a work place nearly in real time.

In the case when a worker accepts a task requiring parts, and the parts are of the type carried by the worker but the worker does not have the necessary quantity of the parts, the worker may send an e-mail to the management center or the terminal used by a person in charge of a transport bike to ask for delivery of the parts to the place of the client.

Parts carried by a worker may be loaded on a transport vehicle. In the case where the management server 11 searches the carried-part information memory section 25 at this time and does not determine that workers in one work area carry the necessary quantity of parts, the parts may be delivered by a transport vehicle. Alternatively, a worker may send e-mail to the transport vehicle terminal 14 to ask for delivery of the parts.

In the embodiment, a worker always carries parts unless the parts are used up. Instead, a worker may not carry parts.

A worker sends the part codes and quantity of received parts, shown on the arrival report screen 13i in FIG. 10, to the management server 11 from the worker terminal 13. At this time, the management server 11 may extract the codes and quantity of necessary parts in the detailed reception information and determine whether they are the same part codes and quantity as the received parts. In case they are different, the management server 11 may send information indicating that the part codes or the quantity is different to the worker terminal 13. This method can prevent erroneous delivery of parts.

The service department terminal 17 may display a progress management screen for a worker. This screen shows the worker code and worker name of each worker and one of the states of no-work, traveling and working based on the progress code reported from each worker. This method can permit the work manager or the like at the management center to adequately grasp the status of each worker.

When the management server 11 receives a task end report, after the progress code in detailed reception information is set to “02” (working), the management server 11 may delete the detailed reception information and the corresponding reception information. This method can suppress an increase in the amount of data to be stored in the individual memory sections in the management server 11.

For example, the latitude and longitude of the worker terminal 13 may be acquired regularly, such as at ten minute intervals.

In the individual embodiments, notification of a work request from a client includes notification that is automatically sent from a machine located at the place of the client. In this case, the machine which may become the target for repair, maintenance or the like has a function for automatically sending information indicating the occurrence of a failure or an event requiring maintenance to the management server 11 when such a failure or event occurs. This information includes data, such as the client code, serial number, status and urgency status. Upon reception of those pieces of information, the management server 11 may store the individual pieces of information in the reception information memory section 20 as reception information and execute the above-described processes.

A machine which may become the target for repair, maintenance or the like has a function for sending notification to the management server 11 when a display or a button provided on the machine is operated. That is, when a client decides that maintenance is needed, the client sends information requesting work to the management server 11 by operating the display or the like provided on the machine. Upon reception of those pieces of information, the management server 11 may store the information in the reception information memory section 20 as reception information and execute the above-described processes.

Although the embodiments of the present invention have been described in connection with the accompanying drawings, the present invention is not limited to those embodiments but may be modified within the scope of the appended claims and their equivalents.

What is claimed is:

1. A method of using a computer system to assist a worker in deciding whether to accept a work item, the method comprising:
storing reception information representing a work request received from a client in a memory device of the computer system;
extracting work items which have not been accepted by the worker from the reception information and sending the extracted work items to a worker terminal used by the worker;
receiving acceptance information corresponding to work items selected by the worker from the unaccepted work items; and
storing information on the worker in the memory device based on the acceptance information.

2. A method of using a computer system to assist a worker who goes to a work place to perform work, in deciding whether to accept a work item, the method comprising:
storing reception information representing a work request received from a client in a memory device;
sending work items in the reception information, which have not been accepted by the worker, to a worker terminal used by the worker;
receiving acceptance information corresponding to work items selected by the worker from the unaccepted work items; and
storing information on the worker in the memory device based on the acceptance information.

3. The method according to claim 2, further comprising sending necessary-part information including identifiers for parts necessary for a work item discriminated from the reception information and a quantity of the necessary parts to either the worker terminal or a transport person terminal used by a transport person who transports parts to the work place.

4. The method according to claim 3, further including discriminating necessary parts and a work method required for a work item based on the reception information, wherein the information on the worker is equivalent to the necessary-part information and the work method.

5. The method according to claim 2, wherein the reception information includes a progress identifier indicating a work status of the worker and the method further includes:
extracting work items including the progress identifier before acceptance from the reception information; and
sending the work items including the progress identifier before acceptance to the worker terminal.

6. The method according to claim 2, wherein the work items to be sent to the worker terminal includes at least one of information on a type of a machine to be a work target, information on a time length expected to be needed for a work item, information on a designated worker, information on whether a work item is urgent or not, and information on parts to be transported by a transport person.

7. The method according to claim 2, further including sending information capable of specifying a location of a worker and a work place, acquired by a position detecting mechanism, to the worker terminal.

8. The method according to claim 2, further comprising a worker identifier, which is an identifier of the worker who has sent the acceptance information into the reception information.

9. The method according to claim 2, further comprising setting a progress identifier for the worker stored in the reception information based on acceptance information as having been received.

10. The method according to claim 2, further comprising sending received-part information on parts transported by a transport person and received by the worker at the work place, to the computer system from the worker terminal.

11. The method according to claim 10, further comprising updating carried-part information on parts carried by the worker and transported-part information on parts carried by the transport person with the received-part information.

12. The method according to claim 10, wherein the received-part information is information corresponding to received parts selected from necessary-part information sent to the terminal used by the worker and is sent from the worker terminal and received by the computer system.

13. The method according to claim 2, further comprising:
receiving information on work subject matter and used-part information on parts used in a task, sent from the worker terminal, by the computer system at a time when the work is done; and
updating the carried-part information, which is information on parts carried by the worker, by the computer system with used-part information.

14. The method according to claim 13, wherein the used-part information is information corresponding to used parts selected from information on necessary parts sent to the terminal used by the worker.

15. The method according to claim 2, further comprising setting a progress identifier for the worker stored in the work reception information as indicating completion of a task by receiving work-completion information sent from the worker terminal when the work is done.

16. The method according to claim 2, further comprising sending work technique information on a work method to the worker terminal in response to a work technique information request sent from the terminal used by the worker.

17. The method according to claim 2, wherein the reception information is classified into a category to which the worker belongs and stored in the memory device, and work items are extracted from the reception information corresponding to the category to which the worker belongs and is sent to the worker terminal.

18. The method according to claim 2, wherein ranking of individual work items for displaying the individual work items arranged on the worker terminal is carried out based on priority information corresponding to the reception information.

19. The method according to claim 18, wherein the ranked individual work items are arranged based on the ranking and the arranged individual work items are sent to the worker terminal.

20. The method according to claim 2, further comprising sending goods information including an identifier of goods discriminated by the reception information, to at least either the worker terminal or a transport person terminal.

21. The method according to claim 3, wherein the necessary-part information is output by an output device connected to the terminal used by the transport person.

22. The method according to claim 3, wherein the necessary-part information or information on used parts is output by an output device connected to the worker terminal.

23. A computer recording medium having recorded computer program instructions which assist a worker in deciding whether to accept a work item when executed by a computer system, the computer program instructions having a plurality of steps for execution by the computer system and comprising:
storing reception information representing a work request received from a client;
extracting work items which have not been accepted by a worker in charge of a work from the reception information;
sending the extracted work items to a worker terminal used by the worker;
receiving acceptance information corresponding to work items selected by the worker and sent from the worker terminal; and
storing information on the worker in a memory device based on the acceptance information.

24. A computer recording medium on which computer program instructions are recorded and which are used to assist a worker who goes to a work place and to perform work, in deciding whether to accept a work item, the computer program instruction having a plurality of steps for execution by a computer system and comprising:
storing reception information representing a work request received from a client;
sending work items in the reception information which have not been accepted by a worker in charge of a work to a worker terminal used by the worker;
receiving acceptance information corresponding to work items selected by the worker and sent from the worker terminal; and
storing information on the worker in a memory device based on the acceptance information.

25. The computer recording medium according to claim 24, wherein the computer program instructions further comprise sending necessary-part information including identifiers for parts necessary for a work item discriminated from the reception information and a quantity of the necessary parts to either the terminal used by the worker or a transport person terminal used by a transport person who transports parts to the work place.

26. The computer recording medium according to claim 24, wherein the computer program instructions further comprise discriminating necessary parts and a work method required for a work item based on the reception information and storing the necessary-part information and information on the work method in the memory device, at the stage of storing the reception information.
